(19) United States
(12) Patent Application Publication
(10) Pub. No.: US 2025/0242536 A1
(43) Pub. Date: Jul. 31, 2025

(54) METHOD FOR PRODUCING A PIPE ASSEMBLY

(71) Applicant: TI Automotive Technology Center GmbH, Rastatt (DE)

(72) Inventor: Thorsten SCHAEFER, Steinfeld (DE)

(21) Appl. No.: 19/039,938

(22) Filed: Jan. 29, 2025

(30) Foreign Application Priority Data
Jan. 29, 2024 (EP) 24154519.3

(51) Int. Cl. B29C 49/20; B29K 23/00; B29L 23/00; F16L 9/12

(52) U.S. Cl. CPC B29C 49/20; F16L 9/12; B29C 2049/2008; B29K 2023/12; B29L 2023/22

(57) ABSTRACT

A method for producing a pipe assembly which has a base body with at least one channel, wherein at least one functional element is allocated to the channel. The functional element is arranged on a tool carrier, the tool carrier is inserted between blow molding tools of a blow mold, a tubular preform is introduced into the blow mold and is put over the tool carrier with the functional element, the blow mold is closed and the pipe assembly is produced from the preform by blow molding. The functional element is connected to the pipe assembly in a materially bonded and/or form-fitting manner, and the tool carrier is equipped with at least one cutting edge, wherein the blow molding tools bear against the at least one cutting edge when the blow mold is closed and press off the preform so that a separation region is formed.

### RELATED APPLICATIONS

The present disclosure claims priority to and the benefit of European Application 24154519.3, filed on Jan. 29, 2024, the entire contents of each of which are incorporated herein by reference.

### FIELD

The disclosure relates to a method for producing a pipe assembly which has a base body with at least one channel, wherein at least one functional element is allocated to the channel.

### BACKGROUND

In electromobility, pipe assemblies are used in order to be able to feed temperature control media to various components of an electric vehicle, such as the batteries or a heat exchanger to control the temperature of the passenger compartment. Batteries exhibit an optimum performance only within a limited temperature range, so it may be necessary to heat or cool the batteries depending on the ambient temperature. It is also necessary to either cool or heat a passenger compartment depending on the ambient temperature. The pipe assembly allows temperature control media with different temperatures to be distributed and fed to different components.

Due to only limited installation space available in electric vehicles, there is a requirement for the pipe assembly to be particularly compact, wherein it is known to incorporate various functional elements directly into the pipe assembly. Furthermore, it is known to produce the pipe assembly using the blow molding process, wherein the pipe assembly can have several channels, and functional elements are arranged in the pipe assembly during the blow molding process. Such an assembly is known, for example, from EP 4 067 048 A1.

The functional elements allocated to the pipe assembly can be accommodated in the interior of the pipe assembly or protrude from the pipe assembly. Protruding functional elements can be connection components via which the pipe assembly can be connected to other components, such as pipes and the like. Connection components are, for example, nozzles or connectors. The connection components are inserted directly into the preform during the blow molding process and are firmly integrated into the pipe assembly by the blow molding process.

In the blow molding process, a tubular preform is inserted into a blow mold, wherein the blow molding tools of the blow mold come to bear against the outside of the preform and define the outer contour of the pipe assembly. The blow mold usually comprises two blow molding tools with a cavity, the blow molding tools can be moved relative to each other, wherein the preform is pressed off at the edge regions of the cavity of the blow molding tools when the blow molding tools are closed. In this region, a seam is created on the pipe assembly to be produced, wherein the pipe assembly is formed in the region of the cavity and protruding material, the slug, remains outside the cavity. The slug is removed from the pipe assembly once the blow molding process is completed.

In case of cylindrical functional elements protruding from the pipe assembly, the blow molding tools can come to bear directly against the functional element so that protruding material can be removed directly. With non-cylindrical functional elements, such as angled or curved connection components, however, the problem can arise that the protruding material cannot be easily removed.

### BRIEF SUMMARY

The present disclosure provides a simple method for producing a pipe assembly in which complex-shaped functional elements can be arranged in the pipe assembly.

In the method according to the disclosure for producing a pipe assembly which has a base body with at least one channel, wherein at least one functional element is allocated to the channel, the functional element is arranged on a tool carrier, the tool carrier is inserted between blow molding tools of a blow mold, a tubular preform is introduced into the blow mold and is put over the tool carrier with the functional element, the blow mold is closed and the pipe assembly is produced from the preform by blow molding, wherein the at least one functional element is connected to the pipe assembly in a materially bonded and/or form-fitting manner, wherein the tool carrier is equipped with at least one cutting edge, wherein the blow molding tools bear against the at least one cutting edge when the blow mold is closed and press off the preform so that a separation region is formed.

In the method according to the disclosure, the cutting edge of the tool carrier comes into contact with the preform and, together with the blow molding tools, the preform is pressed off in the region of the cutting edge so that a separation region is created, via which the protruding material can be separated from the pipe assembly.

The cutting edge can be formed so that the protruding material is already separated from the preform and the resulting pipe assembly when the blow mold is closed. However, it is also conceivable that the protruding material is removed after blow molding has been completed, for example by cutting or tearing. It is advantageous that a defined separation region is created that is independent of the functional element so that functional elements with a complex geometry can also be inserted into the pipe assembly and protruding material can also be removed from the areas of the complex-shaped functional elements.

The tool carrier can be elongated. Such an elongated tool carrier is also known as a lance or spear. Preferably, the tool carrier is formed to accommodate several functional elements. The tool carrier has receiving sections in which the functional elements can be arranged. The receiving sections can, for example, be formed as recesses that are introduced in the tool carrier. Before blow molding, the tool carriers are equipped and fitted with functional elements. Retaining elements can be arranged in the recesses to fix the functional elements in the correct position on the tool carrier.

The tool carrier can be box-shaped and have a top side and two side surfaces. The receiving sections for the functional elements are preferably introduced into the top side. Preferably, the tool carrier is formed so that functional elements arranged in the tool carrier protrude from the tool carrier, wherein protruding sections of the functional elements are integrated into the pipe assembly during blow molding in a materially bonded and/or form-fitting manner. The sections of the functional elements accommodated in the tool carrier protrude from the pipe assembly after blow molding.

Cutting edges can be arranged on the edges between the top side and the side surfaces, the cutting edges extending in the longitudinal direction of the tool carrier. During blow molding, the preform is pressed against the cutting edges and the separation region is created with the pipe assembly on one side and the protruding section, the slug, on the other. The cutting edges can be formed so that the pipe assembly is completely separated from the protruding region during blow molding. However, it is also possible that the protruding region is subsequently removed by reworking along the separation region, for example by tearing or cutting. Due to the cutting edges being arranged between the top side and the side surfaces, the functional element is freely accessible in the finished pipe assembly. Preferably, the cutting edges are linear so that a linear separation region is created.

Preferably, the receiving sections for functional elements are arranged on the top side of the tool carrier.

Due to the preferably box-shaped tool carrier, the preform can also form a box shape in the region, wherein the preform encloses a volume in which the sections of the functional element protruding from the pipe assembly are accommodated. Complex-shaped functional elements, such as angled functional elements or curved functional elements, can also extend into the volume. Due to the cutting edge arranged on the tool carrier, the box-shaped region can be opened after blow molding so that the functional elements are exposed.

If the receiving sections are arranged on the top side and the cutting edges on the edge between the top side and the side surfaces, linear separation regions occur, through which only the section of the preform allocated to the top side remains on the blow molded part, the pipe assembly. The sections associated with the side surfaces and the bottom of the tool carrier are removed after blow molding or detach automatically from the pipe assembly during blow molding. As a result, the sections of the functional elements protruding from the pipe assembly are freely accessible and the protruding material can be easily removed from the mold, even with complex-shaped functional elements.

The functional elements can be connection components. Connection components are, for example, nozzles or connectors through which other components, such as pipes, valves and the like, can be connected to the pipe assembly.

The functional elements can be made of plastic or metallic material.

The blow molding tools can press the preform onto the functional element during blow molding to create a materially bonded and/or form-fitting connection. This allows the functional element to be arranged in the pipe assembly in a fixed and media-tight manner. In case of a materially bonded connection, the functional elements are connected to the pipe assembly in a media-tight manner. At least in case of a form-fitting connection of the functional elements to the pipe assembly, sealing elements such as O-rings can be provided to improve the tightness between the functional element and the pipe assembly.

The functional elements can have undercuts. For example, the functional elements can form connection components that are angled or curved. A functional element can, for example, be formed as a 90-degree bent pipe element. The method according to the disclosure allows such functional elements to be easily integrated into the pipe assembly.

A pipe assembly according to the disclosure is obtainable by the method described above. The functional elements can be connection components with a complex geometry.

### BRIEF DESCRIPTION OF THE DRAWINGS

Some embodiments of the pipe assembly according to the disclosure and the method according to the disclosure are explained in more detail below with reference to the figures. These show, each schematically:

FIG. 1 a pipe assembly;

FIG. 2 a blow mold in section;

FIG. 3 a tool carrier;

FIG. 4 the position of the tool carrier inside the preform during the production of the pipe assembly.

### DETAILED DESCRIPTION

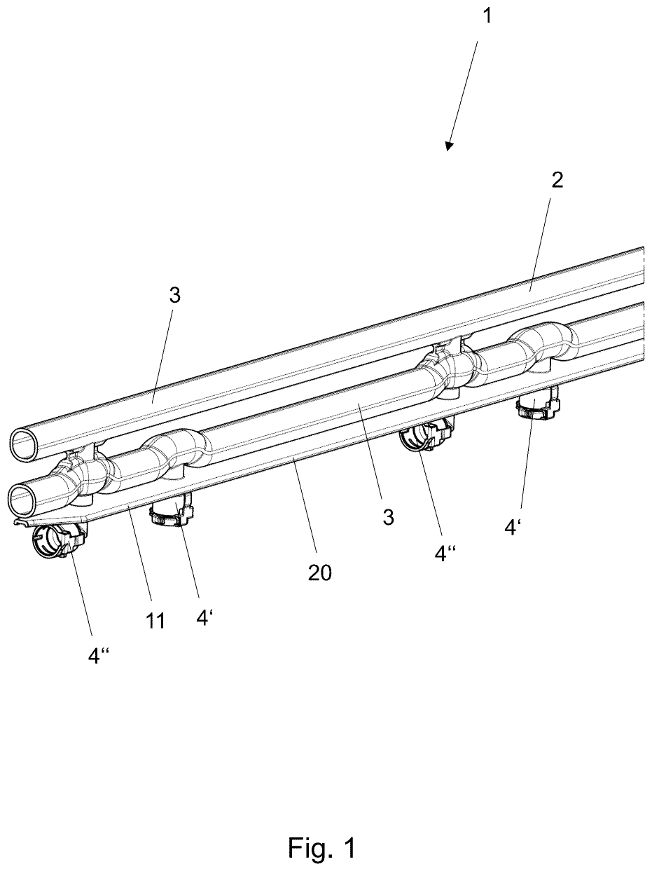

FIG. 1 shows a pipe assembly 1 for the transport of media. The pipe assembly 1 forms a distribution structure for temperature control media, wherein the pipe assembly 1 is used in a temperature control circuit of an electric vehicle. Temperature control media can be distributed via the pipe assembly 1 and fed to the devices to be temperature-controlled, for example the batteries, the electric motors, the power electronics or the heat exchangers of the passenger compartment temperature control system.

The pipe assembly 1 has a base body 2, which is formed as a blow-molded part and wherein several channels 3 are formed from the base body 2. Functional elements 4 are allocated to the channels 3, wherein the functional elements 4 form connection components. In the present case, the functional elements 4 are formed as connecting elements for a direct connection to the vehicle's batteries. Alternatively, the functional elements 4 can be formed as connecting nozzles and serve to accommodate hoses for connecting components to the pipe assembly 1.

First functional elements 4′ are cylindrical and second functional elements 4″ have a 90° angle. At least the curved functional elements 4″ have undercuts.

Like the functional elements 4, the base body 2 is made of polymer material. In the present embodiment, the base body 2 is made of polypropylene and the functional elements 4 are also made of polypropylene. The functional elements 4 are produced by injection molding, wherein the plastic for the functional elements 4 is formed so that the glass transition temperature is in the range of the temperature required for shaping the base body 2 in the blow molding process, resulting in the functional elements 4 being connected with the base body 2 in a materially bonded manner during blow molding.

The functional elements 4 are directly connected to the base body 2 in a materially bonded and captive manner, wherein a flow-conducting connection to the channels 3 exists. Due to the material bond, the functional elements 4 are connected to the base body in a media-tight manner.

The functional elements 4 can also be fixed to the base body in a form-fitting manner. Sealing elements can be arranged between the base body 2 and the functional elements 4 so that the functional elements 4 are connected to the base body 2 in a media-tight manner.

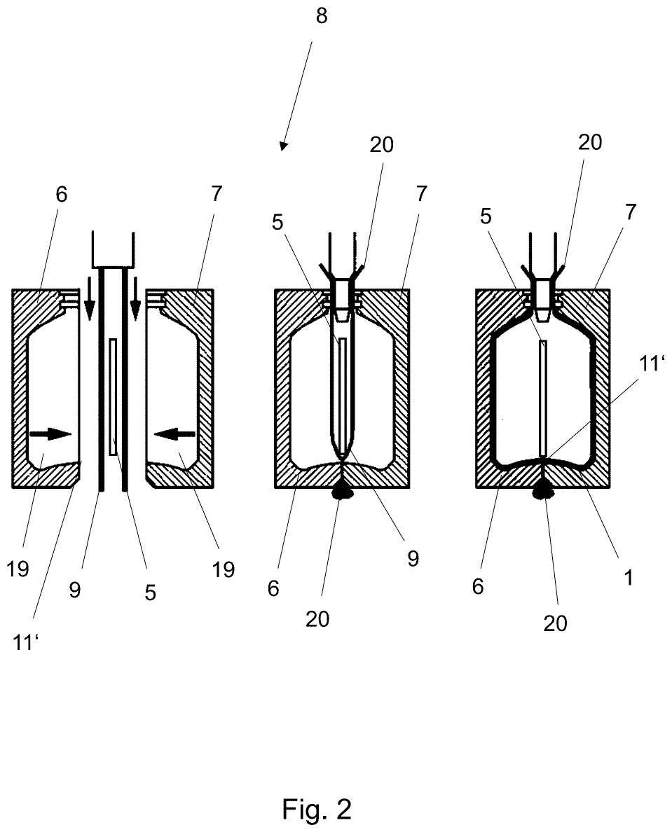

FIG. 2 shows a blow mold 8 with two blow molding tools 6, 7 that can be moved relative to each other. A cavity 19, which defines the outer contour of the pipe assembly 1, is introduced into each of the blow molding tools 6, 7.

To produce the pipe assembly 1, the functional elements 4 are arranged on a tool carrier 5 in a first step and the tool carrier 5 fitted with the functional elements 4 is inserted between the blow molding tools 6, 7. An extruded, tubular preform 9 made of polymer material is then inserted into the blow mold 8 and put over the tool carrier 5 with the functional elements 4.

The blow mold 8 is then closed by moving the blow molding tools 6, 7 towards each other and the pipe assembly 1 is produced from the preform 9 by blow molding. For this purpose, pressure is built up inside the preform 9 via a lance so that the preform 9 is pressed against the wall of the cavities 19, thereby forming the pipe assembly 1. At the same time as shaping, the functional elements 4 are bonded to the pipe assembly 1 in a materially bonded manner. For this purpose, the blow molding tools 6, 7 press the preform 9 onto the functional elements 4 during the blow molding to form a material bond.

The preform 9 is pressed off at the edges of the cavities 19 after the blow molding tools 6, 7 are closed, wherein the pipe assembly is formed inside the cavities 19 and a seam with a first separation region 11′ is created at the opposite edges of the cavities 19. The pressed-off material outside the cavities 19 is protruding material 20, also known as slug. The protruding material 20 is removed along the separation region 11′ after blow molding or the protruding material 20 is already separated along the separation region 11′ when the blow molding tools 6, 7 are closed.

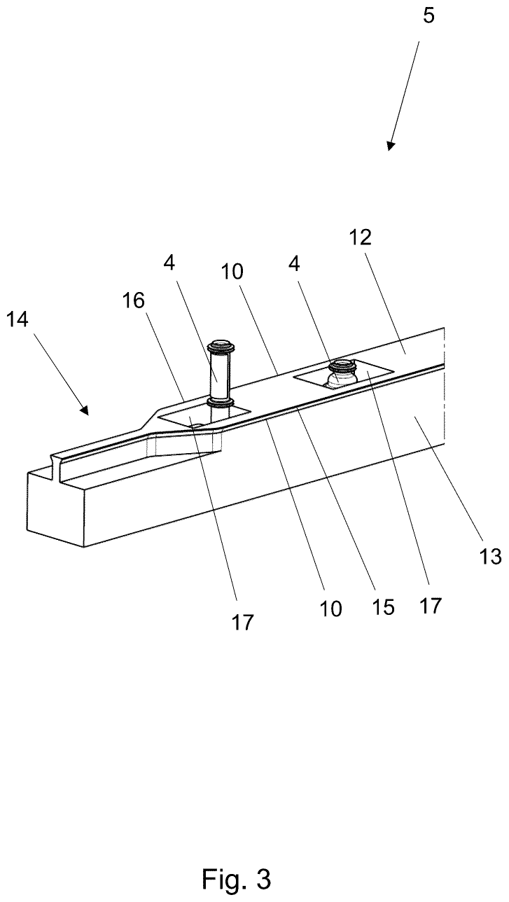

FIG. 3 shows a tool carrier 5 which is provided with functional elements 4 and the preform 9 which is arranged in the blow mold 8 and put over the tool carrier 5. The tool carrier 5 is made of metallic material, is elongated and box-shaped and has a top side 12 and two side surfaces 13, 14. Receiving sections 17 for functional elements 4 are arranged on the top side 12 of the tool carrier 5. Recesses are made in the tool carrier 5 to form the receiving sections 17, into which the functional elements 4 can be inserted. The receiving sections 17 also have retaining elements in order to be able to fix the functional elements 4 in the correct position in the receiving sections 17.

The tool carrier 5 is equipped with two cutting edges 10, wherein the blow molding tools 6, 7 bear against the cutting edges 10 when the blow mold 8 is closed and press off the preform so that a separation region 11 is formed.

The cutting edges 10 are arranged at the edges 15, 16 between the top side 12 and the side surfaces 13, 14 and extend in the longitudinal direction of the tool carrier 5. This embodiment results in two linear separation regions 11 on the pipe assembly 1 after blow molding.

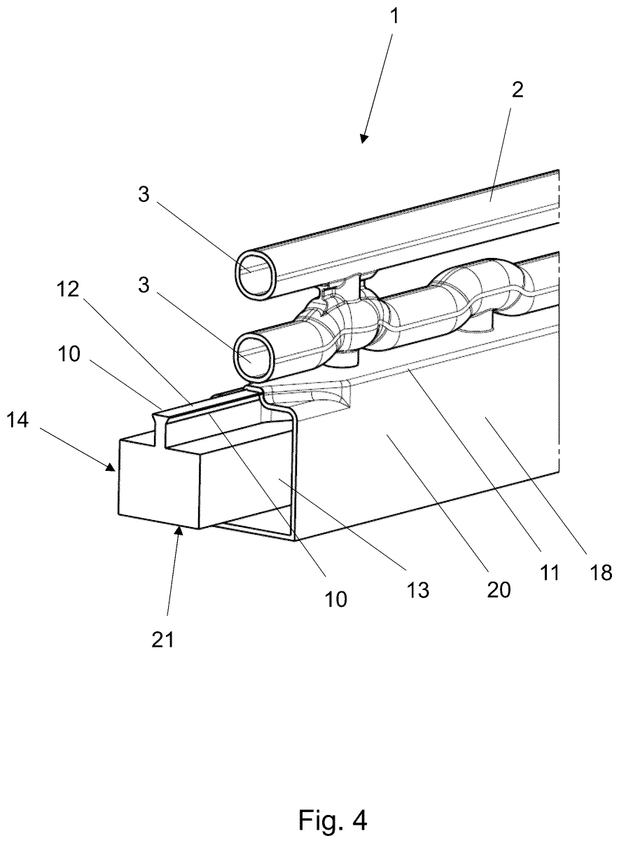

FIG. 4 shows in detail a region of the preform 9 or the pipe assembly 1 with the tool carrier 5 held in it during blow molding. The blow mold 8 is formed so that a box-shaped region 18 is formed from the preform 9 around the tool carrier 5, the region can be opened after blow molding along the separation regions 11 formed by the cutting edges 10 so that the functional elements 4 are exposed.

The receiving sections 17 arranged on the top side 12 of the tool carrier 5 and the cutting edges 10 on the edges 15, 16 between the top side 12 and the side surfaces 13, 14 result in linear separation regions 11 due to which only the section of the preform 9 allocated to the top side 12 remains after the protruding material 20 has been cut off. The sections associated with the side surfaces 13, 14 and the bottom 21 of the tool carrier 5 form the protruding material 20 and are removed after blow molding or detach automatically from the pipe assembly 1 during blow molding. As a result, the sections of the functional elements 4 protruding from the pipe assembly 1 are freely accessible and removing of the protruding material 20 is easily possible, even with complex-shaped functional elements 4.

1. A method for producing a pipe assembly which has a base body with at least one channel, wherein at least one functional element is allocated to the channel, wherein the functional element is arranged on a tool carrier, the tool carrier is inserted between blow molding tools of a blow mold, a tubular preform is introduced into the blow mold and is put over the tool carrier with the functional element, the blow mold is closed and the pipe assembly is produced from the preform by blow molding, wherein the at least one functional element is connected to the pipe assembly in a materially bonded and/or form-fitting manner, characterized in that the tool carrier is equipped with at least one cutting edge, wherein the blow molding tools bear against the at least one cutting edge when the blow mold is closed and press off the preform so that a separation region is formed.

2. The method according to claim 1, wherein the tool carrier is elongated.

3. The method according to claim 1, wherein the tool carrier is box-shaped and has a top side and two side surfaces.

4. The method according to claim 3, wherein cutting edges are arranged on the edges between the top side and the side surfaces, the cutting edges extending in the longitudinal direction of the tool carrier.

5. The method according to claim 4, wherein receiving sections for functional elements are arranged on the top side of the tool carrier.

6. The method according to claim 3, wherein the blow mold is formed so that a box-shaped region is formed around the tool carrier from the preform during blow molding, the region being opened, after blow molding, along the separation region formed by the cutting edges.

7. The method according to claim 6, wherein the separation region is linear.

8. The method according to claim 1, wherein the functional element is a connection component.

9. The method according to claim 1, wherein the functional elements form undercuts.

10. The method according to claim 1, wherein the blow molding tools press the preform onto the functional element during blow molding to form a material bond.

11. A pipe assembly, produced by the method according to claim 1.

12. The pipe assembly according to claim 11, wherein the functional elements are connection components.

13. A method for producing a pipe assembly which has a base body with at least one channel, wherein at least one functional element is allocated to the channel, comprising the steps of:
arranging the functional element on a tool carrier;
inserting the tool carrier between blow molding tools of a blow mold;
introducing a tubular preform into the blow mold such that the tubular preform is placed over the tool carrier with the functional element; and
closing the blow mold and producing the pipe assembly from the preform by blow molding, wherein the at least one functional element is connected to the pipe assembly in a materially bonded and/or form-fitting manner;
wherein the tool carrier is equipped with at least one cutting edge, wherein the blow molding tools bear against the at least one cutting edge when the blow mold is closed and press off the preform so that a separation region is formed.
